(19) United States
(12) Patent Application Publication
(10) Pub. No.: US 2025/0309997 A1
(43) Pub. Date: Oct. 2, 2025

(54) DISTRIBUTING AN ENTANGLED STATE AMONG MULTIPLE NODES USING QUANTUM EMITTERS

(71) Applicant: Cisco Technology, Inc., San Jose, CA (US)

(72) Inventors: Eneet Kaur, Somerville, MA (US); Jiapeng Zhao, Kenmore, WA (US); Michael John Kilzer, Los Angeles, CA (US)

(21) Appl. No.: 18/622,083

(22) Filed: Mar. 29, 2024

(51) Int. Cl. H04B 10/70

(52) U.S. Cl. CPC H04B 10/70

(57) ABSTRACT

An embodiment provides for distribution of an entangled state (e.g., GHZ state, etc.) through use of an optical channel coupled with electron-nuclear memories, such as silicon vacancy quantum memories, and near-deterministic Bell measurements between electronic spins. The embodiment provides electron-nuclear spin swapping and deterministically generates electron-electron entanglement. Nuclear spins can be used for memories, and repeated Bell measurements can be used to generate entanglements between electrons. Thus, the embodiment obtains a deterministic GHZ projection and prepares the GHZ state in fixed circuit depth.

### TECHNICAL FIELD

The present disclosure relates to communication systems.

### BACKGROUND

Generating a multipartite entangled state, such as a Greenberger-Horne-Zeilinger (GHZ) state, over optical fibers can be difficult due to loss. Further, linear optics limit the ability to perform GHZ measurements.

### BRIEF DESCRIPTION OF THE DRAWINGS

FIG. 1 is a block diagram of an example communication environment in which generation of an entangled state, such as a Greenberger-Horne-Zeilinger (GHZ) state, over multiple nodes may be implemented, according to an example embodiment.

FIG. 2 illustrates a quantum memory and corresponding operations, according to an example embodiment.

FIG. 3 illustrates a flowchart of a method for generating an entangled state (e.g., GHZ state, etc.) over multiple nodes, according to an example embodiment.

FIG. 4 illustrates an example communication environment and corresponding states and operations to establish entanglement between a central node and end nodes for generating a Greenberger-Horne-Zeilinger (GHZ) state, according to an example embodiment.

FIG. 5A illustrates an example communication environment with a central node having entanglement with individual end nodes for generating a Greenberger-Horne-Zeilinger (GHZ) state, according to an example embodiment.

FIG. 5B illustrates a central node generating a Greenberger-Horne-Zeilinger (GHZ) state among end nodes of FIG. 5A, according to an example embodiment.

FIG. 5C illustrates the example communication environment of FIG. 5A with a Greenberger-Horne-Zeilinger (GHZ) state established between end nodes, according to an example embodiment.

FIG. 6A illustrates an example communication environment with a central node having entanglement with individual end nodes for generating a Greenberger-Horne-Zeilinger (GHZ) state among several end nodes, according to an example embodiment.

FIG. 6B illustrates a central node generating a Greenberger-Horne-Zeilinger (GHZ) state among the end nodes of FIG. 6A, according to an example embodiment.

FIG. 6C illustrates the example communication environment of FIG. 6A with a Greenberger-Horne-Zeilinger (GHZ) state established between several end nodes, according to an example embodiment.

FIG. 7 illustrates a flowchart of a generalized method for generating an entangled state between three or more nodes, according to an example embodiment.

FIG. 8 illustrates a hardware block diagram of a computing device configured to perform functions associated with operations discussed herein, according to an example embodiment.

### DESCRIPTION OF EXAMPLE EMBODIMENTS

### Overview

An embodiment provides for distribution of an entangled state (e.g., GHZ state, etc.) through use of an optical channel coupled with electron-nuclear memories, such as silicon vacancy quantum memories, and near-deterministic Bell measurements between electronic spins. The embodiment provides electron-nuclear spin swapping and deterministically generates electron-electron entanglement. Nuclear spins can be used for memories, and repeated Bell measurements can be used to generate entanglements between electrons. Thus, the embodiment obtains a deterministic GHZ projection and prepares the GHZ state in fixed circuit depth.

### EXAMPLE EMBODIMENTS

An embodiment provides for distribution of an entangled state (e.g., GHZ state, etc.) through use of an optical channel coupled with electron-nuclear memories, such as silicon vacancy quantum memories, and near-deterministic Bell measurements between electronic spins. A Bell state generally refers to four specific maximally entangled quantum states of two qubits. A GHZ state generally refers to a certain type of entangled quantum state that involves at least three subsystems (or qubits). Bell entanglement refers to the entanglement between two particles (or subsystems or qubits), where members (or qubits) of a pair share a quantum state (e.g., one of the Bell states is a superposition of 00 and 11, but other Bell states can differ in phase as well), such that changing the state of one predictably changes the state of the other. The GHZ entanglement is an entanglement among three particles (or subsystems or qubits).

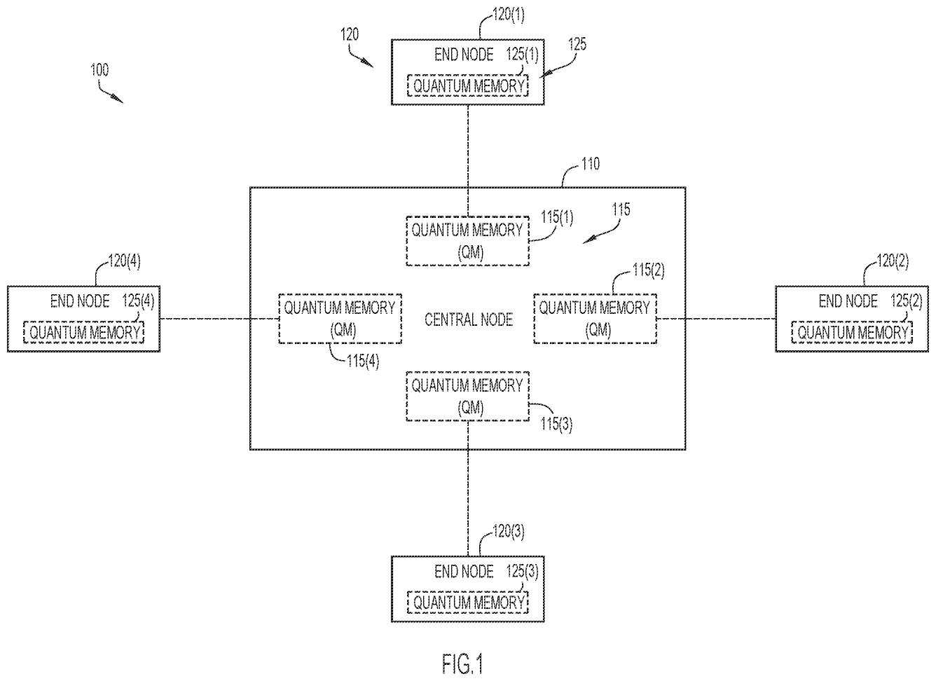

FIG. 1 is a block diagram of an example communication environment 100 in which generation of an entangled state (e.g., GHZ state, etc.) over multiple nodes may be implemented, according to an example embodiment. Initially, communication environment 100 includes a central node 110 and two or more end nodes 120 that may communicate via any protocols. By way of example, communication environment may include four end nodes 120(1), 120(2), 120(3), and 120(4). However, communication environment 100 may include any quantity of central and end nodes, where a GHZ or other entangled state may be generated over any quantity of end nodes in substantially the same manners described below.

Central node 110 includes one or more quantum memories 115. The quantum memories may include, or be implemented by, any conventional or other quantum memories (e.g., silicon vacancy quantum memories, etc.). The quantum memories may include electrons (or electron memory) and nuclei (or nuclear memory) representing qubits (or states) for generating or distributing an entangled state (e.g., GHZ state, etc.) among the end nodes as described below. By way of example, central node 110 may include four quantum memories 115(1), 115(2), 115(3), and 115(4) corresponding to end nodes 120(1), 120(2), 120(3), and 120(4).

In addition, an end node 120 may include one or more quantum memories 125 (e.g., quantum memory 125(1) of end node 120(1), quantum memory 125(2) of end node 120(2), quantum memory 125(3) of end node 120(3), quantum memory 125(4) of end node 120(4), etc.). Memories in the end nodes are optional, and may not be needed for certain situations. For quantum key distribution (QKD) type applications, for example, where we can measure the state immediately, just photons would suffice. Quantum memories 125 may include, or be implemented by, any conventional or other quantum memories. Quantum memories 125 may contain quantum information (or states) for generating or distributing the Greenberger-Horne-Zeilinger (GHZ) state among the end nodes in certain applications (e.g., when quantum information needs to be maintained for longer periods of time).

An embodiment generates (or distributes or shares) a Greenberger-Horne-Zeilinger (GHZ) entanglement or state between end nodes 120. Central node 110 is equipped with quantum memories 115 and a mechanism to generate Bell pairs, and performs small scale quantum computation. End nodes 120 may also be equipped with small scale quantum memories 125 (e.g., for applications requiring maintenance of quantum information for longer periods of time). The techniques described herein may be expanded to any number of end nodes. The resulting GHZ state may be used in communication environment 100 for quantum sensing, conference key distribution, and distributed quantum computing.

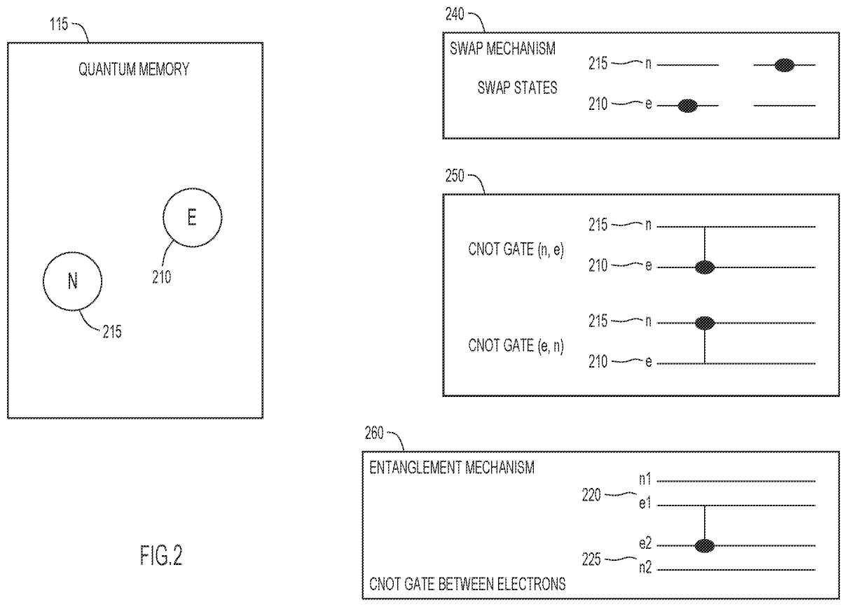

With continued reference to FIG. 1, FIG. 2 illustrates a quantum memory and operations of central node 110, according to an example embodiment. A quantum memory 115 (e.g., quantum memory 115(1), 115(2), 115(3), 115(4), etc.) may include electrons (or electron memory) and nuclei (or nuclear memory) representing quantum information (or states). Quantum memory 115 may store various information or states, where an electron may represent an electron spin (or state) and a nucleus may represent a nuclear spin (or state). Electrons are more interactive and may lose information (or states) quicker, while nuclei have long coherence times and may be used to represent (or store) quantum information (spins or states) for a longer period of time. Central node 110 may include various conventional or other mechanisms (e.g., gates, circuits, etc.) to perform operations in relation to quantum memory 115.

For example, central node 110 may include a swap mechanism 240, a controlled NOT (CNOT) gate 250, and an entanglement mechanism 260. Swap mechanism 240 swaps a state (or spin) of an electron 210 and a state (or spin) of a nucleus 215 of a quantum memory 115. CNOT gate 250 is generally a quantum logic gate that may be used to entangle (and disentangle) Bell states. The input includes a control qubit and a data qubit, where the qubits contain quantum information (states or spins). The CNOT gate basically toggles the data qubit when the control qubit has a state of |1>. For example: the input qubits with states of |0>|0> produce outputs including the control qubit (|0>) and resulting qubit from the toggle operation (|0>); the input qubits with Bell states of |0>|1> produce outputs including the control qubit (|0>) and resulting qubit of the toggle operation (|1>); the input qubits with Bell states of |1>|0> produce outputs including the control qubit (|1>) and resulting qubit of the toggle operation (|1>); and the input qubits with Bell states of |1>|1> produce outputs including the control qubit (|1>) and resulting qubit of the toggle operation (|0>).

The expression CNOT gate (n, e) indicates that the state of the nucleus is the control, and the state of the electron is the data to toggle. The expression CNOT gate (e, n) indicates that the state of the electron is the control, and the state of the nucleus is the data to toggle. The CNOT gate may be used to swap (or entangle) the states of the electron and the nucleus in the quantum memory.

Entanglement mechanism 260 generates a Bell state entanglement between electron 220 of a quantum memory and an electron 225 of a different quantum memory 115. Since the electrons of quantum memory 115 may lose information quicker, the state of the entangled electrons may be swapped (or entangled) with a state of nucleus (or spin of a nucleus (protons and neutrons)) in the quantum memory to store the entangled state for a longer period of time. This swapping (or entanglement) may be performed by a controlled NOT (or CNOT) gate or circuit of the central node. This basically involves exciting the electron with a laser, where the emitted photons from the two electrons are sent to a beamsplitter and a Bell swap is performed. This is a probabilistic process that is repeated until success.

With continued reference to FIGS. 1-2, FIGS. 3, 4, 5A-5C, and 6A-6C illustrate a method 300 for generating an entangled state (e.g., GHZ state, etc.) over multiple end nodes, according to an example embodiment. Initially, central node 110 of communication environment 100 generates and distributes a corresponding entangled photon (e.g., Bell state entanglement) to individual end nodes 120(1), 120(2), 120(3), and 120(4) at operation 305. The central node includes a corresponding quantum memory (e.g., quantum memory 115(1), 115(2), 115(3), 115(4)) for each end node 120 (e.g., end node 120(1), 120(2), 120(3), 120(4)) to facilitate the entanglement. The central node transfers a state of an electron (entangled with the corresponding photon) to a nucleus of the corresponding quantum memory for long-term memory (e.g., via swap mechanism 240).

Once the corresponding photon is sent to end nodes 120(1), 120(2), 120(3), 120(4), the end nodes communicate to central node 110 about the received photon. The central node receives communications from end nodes 120(1), 120(2), 120(3), 120(4) via classical communication at operation 310. The end nodes communicate to the central node 110 about the received photon by heralding the successful absorption of the photon at the end node. Since reception of the photon is uncertain, classical communication (or heralding) is used to reliably communicate results of the photon transmission to the central node.

When the corresponding photon is received by (or reflected from) end nodes 120(1), 120(2), 120(3), 120(4), the entanglement of the corresponding end node and quantum memories 115(1), 115(2), 115(3), and 115(4) is established. This distributes Bell entanglement between quantum memories 115(1), 115(2), 115(3), 115(4) of central node 110 and corresponding end nodes 120(1), 120(2), 120(3), 120(4). The entanglement of the photon and the electron spin of the central node is established at creation of the photon. When the photon is received by an end node, and the photon is absorbed by the electron spin of the end node, the central node and end node are entangled. The swap between electron spin and nuclear spin at the central node may also be performed after transmission of the photon to the end node. However, when a signal is received indicating that the photon did not reach the end node, the neutron is measured to remove the state, the nuclear spin is reinitialized, and none of the entangling operations described below are performed for the end node.

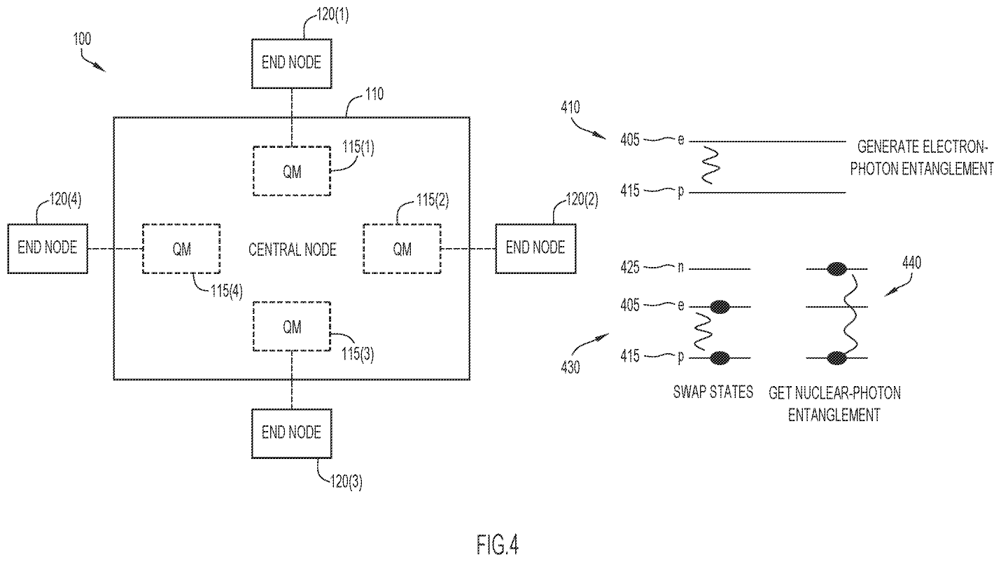

The distribution of the entanglement between the central node and end nodes may be accomplished as illustrated in FIG. 4. A quantum memory 115(1) of central node 110 is initially prepared (or initialized), and an electron 405 of the quantum memory is excited with lasers or other light or energy source to generate emission of a photon 415. By conditioning the photon emission, electron 405 and photon 415 are in a maximally entangled state at stage 410. The photon is sent (e.g., over a quantum or optical channel) to a corresponding end node 120(1).

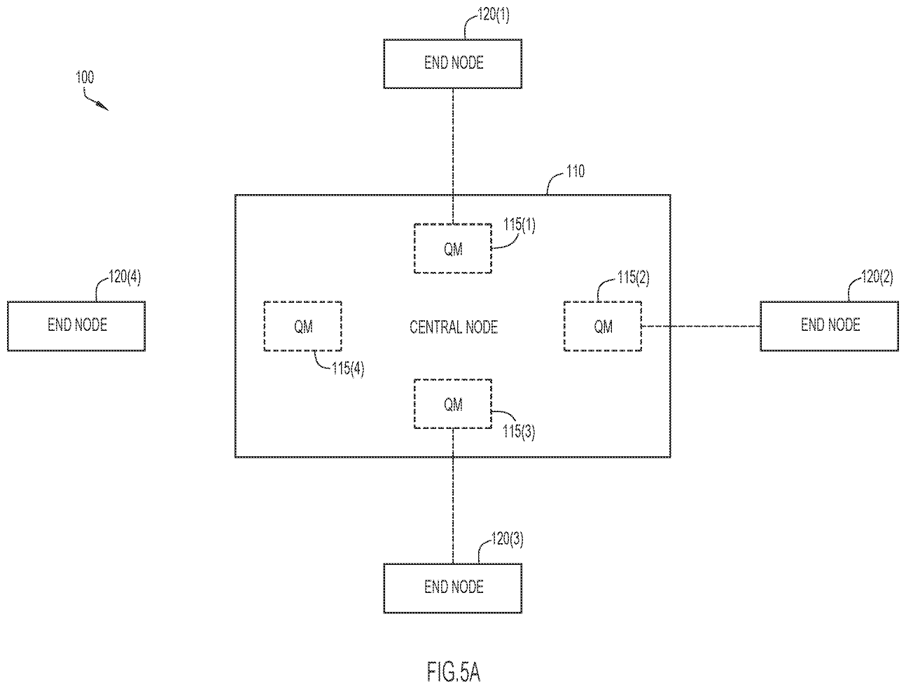

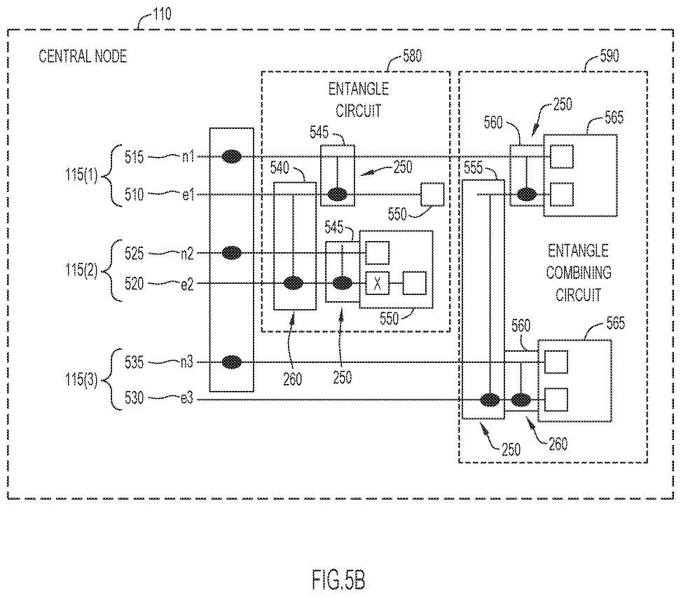

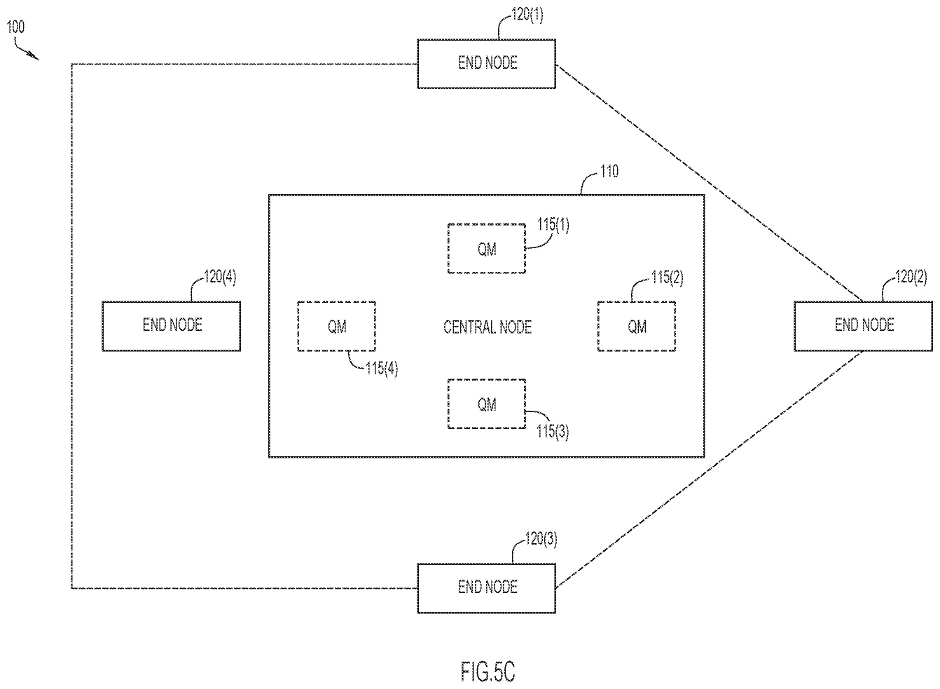

Central node 110 transfers (e.g., via swap mechanism 240) the state of electron 405 (entangled with photon 415 at stage 430) to a nucleus 425 of quantum memory 115(1) for long-term memory at stage 440 (effectively entangling photon 415 of end node 120(1) with the state of nucleus 425 of quantum memory 115(1)). This starts a timer which keeps track of the duration the state is stored in a nuclear spin of nucleus 425. The timer is there to ensure that operation of circuit 590 (FIG. 5B) completes prior to the decoherence time of the nuclear spin.

Once corresponding photon 415 is sent to end node 120(1), the end node communicates to central node 110 about the received photon. The communication indicates whether or not the photon has been received. When photon 415 is received by (or reflected from) end node 120(1), the entanglement of photon 415 and nucleus 425 of quantum memory 115(1) is established. This distributes Bell entanglement between quantum memory 115(1) of central node 110 and a corresponding end node 120(1). The above process is repeated for each quantum memory 115(2), 115(3), 115(4) and corresponding end node 120(2), 120(3), 120(4) intended for the Greenberger-Horne-Zeilinger (GHZ) state to generate a Bell entanglement between central node 110 and those end nodes.

Although the entangled state has been stored in nuclei of quantum memories 115(1), 115(2), 115(3), 115(4) of central node 110 as described above, the central node knows which photons actually reached the end nodes to establish the entanglement based on the communications. Accordingly, central node 110 may have established Bell state entanglement with all or a portion of end nodes 120(1), 120(2), 120(3), 120(4).

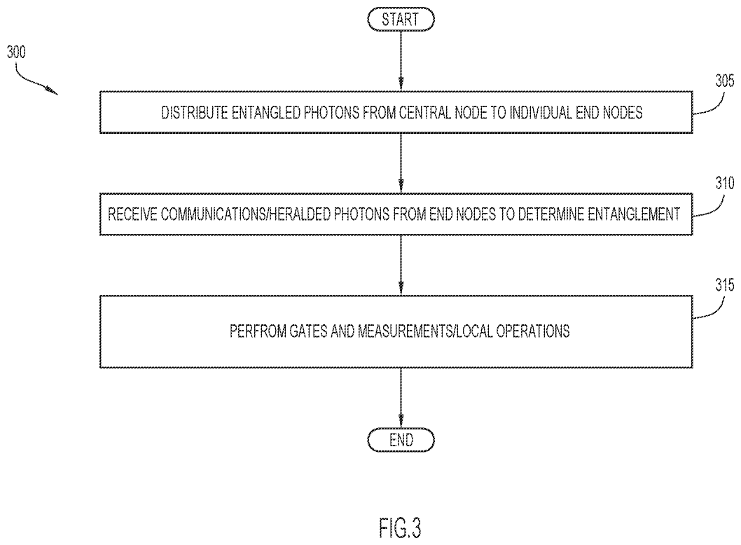

Once the Bell state entanglements are established between the central node and individual end nodes, central node 110 entangles and measures the nuclear states of quantum memories corresponding to end nodes entangled with the central node (e.g., via gates, local operations, etc.) to distribute the Greenberger-Horne-Zeilinger (GHZ) state among those end nodes at operation 315 (FIG. 3). By way of example, FIG. 5A illustrates communication environment 100 with central node 110 having entanglement with certain individual end nodes 120(1), 120(2), 120(3) for generating a Greenberger-Horne-Zeilinger (GHZ) state. In this example case, end node 120(4) had not established entanglement with the central node (e.g., had not received the corresponding photon).

The Greenberger-Horne-Zeilinger (GHZ) state may be established by central node 110. FIG. 5B illustrates central node 110 generating a Greenberger-Horne-Zeilinger (GHZ) state among end nodes 120(1), 120(2), 120(3) of FIG. 5A. Quantum memories 115(1), 115(2), 115(3) each store an entanglement with a (corresponding photon of) end node 120(1), 120(2), 120(3) in nuclei 515, 525, and 535. Central node 110 initially prepares an electron-photon maximally entangled state in substantially the same manner described above (e.g., generates photons (for end nodes 120(1) and 120(2)) that are respectively entangled with electron 510 of quantum memory 115(1) and electron 520 of quantum memory 115(2)). Central node 110 entangles electrons 510, 520 from quantum memories 115(1), 115(2) by Bell swapping the entanglement between the photons via (e.g., entanglement mechanism 260 of) an entangle circuit 580 at operation 540. The entanglement between quantum memories 115(1), 115(2) and corresponding end nodes 120(1), 120(2) have been confirmed as described above (e.g., operation 310).

For each quantum memory 115(1), 115(2) (having a state of nucleus 515, 525 representing entanglement with a corresponding end node 120(1), 120(2)), the states of the electron and nucleus are first swapped via (e.g., a controlled NOT (CNOT) gate 250) and additional entanglement is created between the nuclei 515 and electron 510 and nuclei 525 and electron 520 via the entangle circuit 580 at operation 545 (effectively entangling the states of nuclei 515, 525 via entanglement of electrons 510, 520). In other words, electrons 510, 520 are used to entangle the states of nuclei 515, 525 (representing entanglement of end nodes 120(1), 120(2) with central node 110), thereby creating (or projecting) an entangled state between end nodes 120(1), 120(2) (based on the corresponding entanglement with the received photons), and the nuclei 515 and 525 and the electrons 510 and 520. The operation time of a CNOT gate is much shorter than the coherence time of a quantum memory which guarantees the entanglement between nuclear states of quantum memories. In this case, the state of electron 510 is entangled with the state of electron 520 (entangled with end node 120(2)), where the state of electron 510 of quantum memory 115(1) is swapped (or entangled) with the state of nuclei 515 of quantum memory 115(1) (entangled with end node 120(1)). Currently, the states of the photons of end nodes 120(1), 120(2), electrons 510 and 520, and the nuclei 515 and 525 are in a multi qubit entangled state. Entangled electrons 510, 520, and nucleus 525 are measured to remove the states from their respective quantum memories 115(1), 115(2) at operation 550. This reduces the multi qubit entangled state to entanglement between the photons of end nodes 120(1), 120(2), and the nuclei 515. The measurements remove entanglement between the central node and end node 120(2). However, the state of nucleus 515 (still entangled to the end nodes 120(1) and 120(2)) remains to distribute the entanglement to additional end nodes as described below.

The above process is repeated for quantum memory 115(3) to distribute the Greenberger-Horne-Zeilinger (GHZ) entanglement or state between end nodes 120(1), 120(2), 120(3). Central node 110 entangles electrons 510, 530 from quantum memories 115(1), 115(3) by Bell swapping between the photons via (e.g., entanglement mechanism 260 of) entangle combining circuit 590 at operation 555. The entanglement between quantum memory 115(3) and corresponding end node 120(3) has been confirmed as described above (e.g., operation 310).

For each quantum memory 115(1) (having a state of nucleus 515 entangled with corresponding end nodes 120(1), 120(2)) and 115(3) (having a state of nucleus 535 entangled with a corresponding end node 120(3)), the states of the electron and nucleus are entangled via (e.g., a controlled NOT (CNOT) gate 250 of) entangle combining circuit 590 at operation 560 (effectively entangling the states of nuclei 515, 535 via entanglement of electrons 510, 530). In other words, electrons 510, 530 are used to entangle the states of nuclei 515, 535, end nodes 120(1), 120(2), 120(3) (based on the corresponding entanglement with the received photons) and the electrons 510 and 530. Entangled electrons 510, 530, and nuclei 515, 535 are measured to remove the states from their respective quantum memories 115(1), 115(3) at operation 565 and the multipartite entangled state between end nodes 120(1), 120(2), 120(3), electrons 510, 530, and nuclei 515 and 535. This removes the entanglement between central node 110 and end nodes 120(1), 120(3), and 120(2). A timer keeping track of the process starting at 440 (FIG. 4) stops once all nuclear spins are measured. The time recorded is compared with the decoherence time of the nuclear spins. If the time is less than the decoherence time, the multipartite entangled state is kept, otherwise the multipartite entangled state is discarded. The process could then be repeated, if desired, to reattempt.

By way of example, the resulting entangled (or Greenberger-Horne-Zeilinger (GHZ)) state may be expressed in quantum notation (for N nodes or qubits) as: GHZ=(|0₁ . . . 0_{N}>+|1₁ . . . 1_{N}>)/√2. For example, the entangled state may be expressed for three nodes or qubits as: GHZ=(|000>+|111>)/√2. However, the expression may be applied to any quantity of nodes (or qubits).

FIG. 5C illustrates example communication environment 100 of FIG. 5A with a Greenberger-Horne-Zeilinger (GHZ) state established between end nodes 120(1), 120(2), 120(3) (which have entanglements decoupled from central node 110). An embodiment may combine entanglements between the central node and individual end nodes in any order or fashion (e.g., use any quantum memory to combine the entanglements, etc.).

An embodiment may extend the technique described above to additional end nodes. For example, an entangle circuit 580 may be employed to process (or entangle) states of nuclei and electrons of each pair of quantum memories (115(j), 115(j+1)), where j is an odd number greater than or equal to one and less than a quantity of the end nodes for the GHZ entanglement. An entangle combining circuit 590 may be employed to combine the entanglements from entangle circuits 580 for additional quantum memories. For example, an initial entangle combining circuit 590 may combine entanglements of the first three quantum memories 115(1), 115(2), 115(3), and subsequent entangle combining circuits may combine entanglements from quantum memories (115(k), 115(k+1)), where k is an even number greater than or equal to four and less than a quantity of end nodes for the GHZ entanglement. The creation of the entanglement (or Greenberger-Horne-Zeilinger (GHZ) state) may be accomplished in two time steps, which must be less than the nuclear spin decoherence time in total

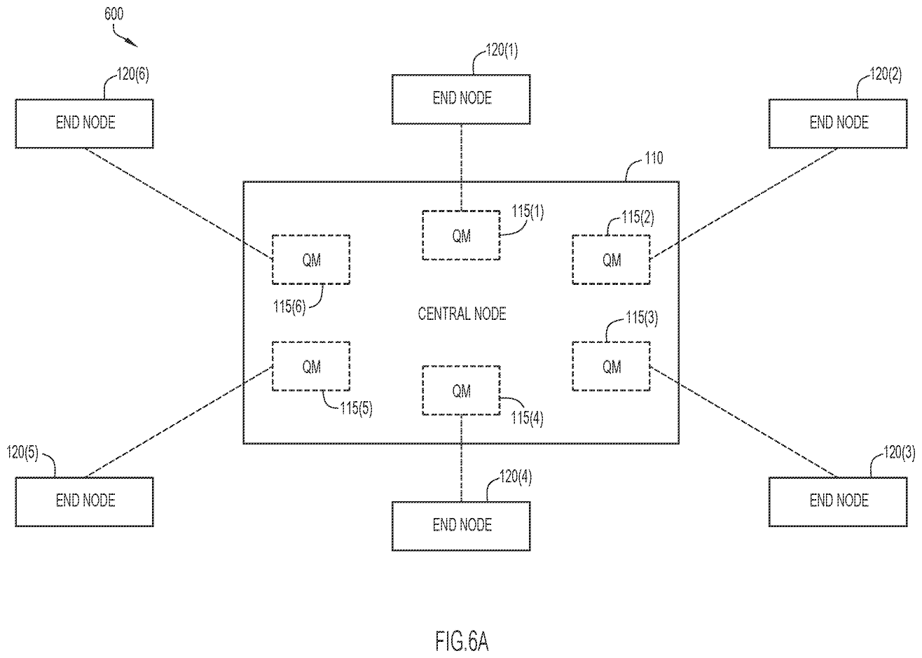

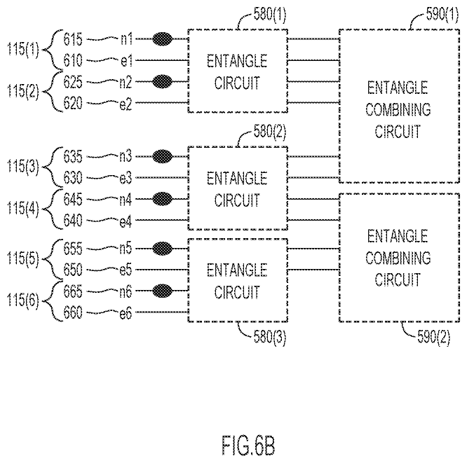

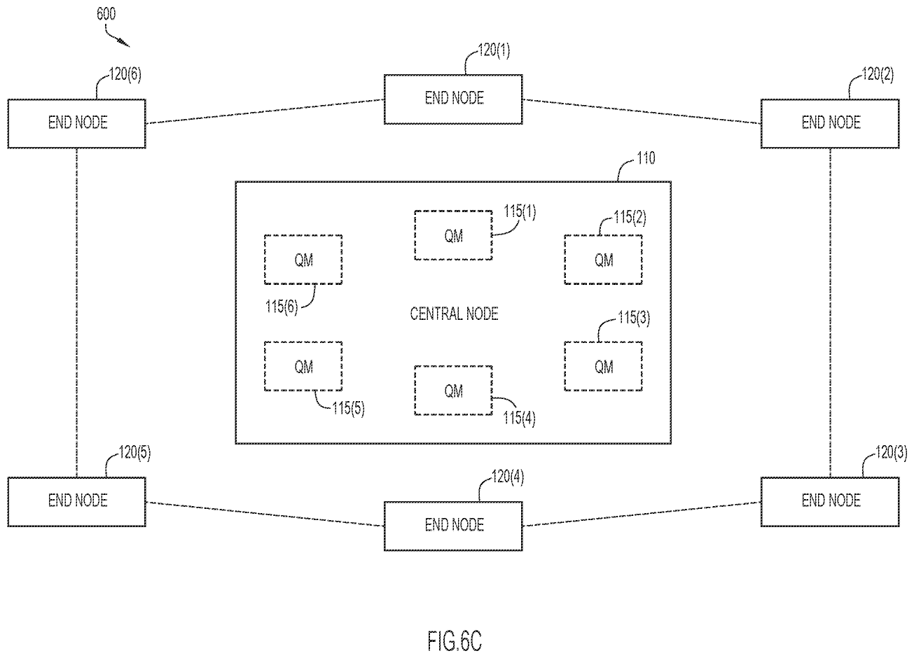

FIG. 6A illustrates an example communication environment 600 with central node 110 including quantum memories 115(1), 115(2), 115(3), 115(4), 115(5), 115(6) and having entanglement with corresponding end nodes 120(1), 120(2), 120(3), 120(4), 120(5), 120(6) for generating an entangled (Greenberger-Horne-Zeilinger (GHZ)) state among those end nodes, according to an example embodiment. Central node 110 may establish entanglement with each of the individual end nodes in substantially the same manner described above.

FIG. 6B illustrates central node 110 generating an entangled (Greenberger-Horne-Zeilinger (GHZ)) state among end nodes 120(1), 120(2), 120(3), 120(4), 120(5), 120(6) by combining the individual entanglements with central node 110 using entangle circuit 580 and entangle combining circuit 590. By way of example, central node 110 may include entangle circuits 580(1), 580(2), 580(3), each substantially similar to entangle circuit 580 described above, to process (or entangle) nuclear and electronic spins of each pair of quantum memories in substantially the same manner described above.

In this example case, entangle circuit 580(1) may entangle the state of electron 610 of quantum memory 115(1) and the state of electron 620 of quantum memory 115(2) by Bell swapping between two corresponding photons in substantially the same manner described above. For each quantum memory 115(1), 115(2) (having states of nuclei 615, 625 representing entanglement with a corresponding end node 120(1), 120(2)), the states of the electrons and nuclei are swapped (or entangled) via (e.g., controlled NOT (CNOT) gate 250) of entangle circuit 580(1) in substantially the same manner described above. The state of electron 610 is entangled with the state of electron 620 (corresponding to end node 120(2)), where the state of electron 610 of quantum memory 115(1) is swapped (or entangled) with the state of nuclei 615 of quantum memory 115(1) (entangled with end node 120(1)). Entangled electrons 610, 620, and nucleus 625 are measured to remove the states from their respective quantum memories 115(1), 115(2) in substantially the same manner described above, thereby creating an entangled (or Greenberger-Horne-Zeilinger (GHZ)) state between corresponding end nodes 120(1), 120(2) (e.g., shown by the connection between end nodes 120(1), 120(2) in FIG. 6C). The measurements remove entanglement between the central node and end node 120(2). However, the state of nucleus 615 (still entangled to end nodes 120(1) and 120(2)) remains to distribute the entanglement to additional end nodes as described below.

The above process is repeated using entangle circuit 580(2) (for electrons 630, 640 and nuclei 635, 645 of quantum memories 115(3), 115(4)) to entangle corresponding end nodes 120(3) and 120(4), and entangle circuit 580(3) (for electrons 650, 660 and nuclei 655, 665 of quantum memories 115(5), 115(6)) to entangle corresponding end nodes 120(5) and 120(6).

By way of further example, central node 110 may include entangle combining circuits 590(1), 590(2), each substantially similar to entangle combining circuit 590 described above, to combine entanglements of entangle circuits 580(1), 580(2), 580(3) in substantially the same manner described above. In this example case, central node 110 entangles the state of electron 630 of quantum memory 115(3) with a state of electron 610 in quantum memory 115(1) by Bell swapping between corresponding photons via (e.g., entanglement mechanism 260 of) entangle combining circuit 590(1) in substantially the same manner described above. For quantum memories 115(1) (having a state of nucleus 615 entangled to corresponding end nodes 120(1), 120(2)) and 115(3) (having a state of nucleus 635 representing entanglement with a corresponding end node 120(3)), the states of the electrons and nuclei are swapped (or entangled) via (e.g., a corresponding controlled NOT (CNOT) gate 250 of) entangle combining circuit 590(1) (effectively entangling the states of nuclei 615, 635 via entanglement of electrons 610, 630).

The state of electron 610 is entangled with the state of electron 630, where the entangled state of electrons of quantum memory 115(1) is swapped (or entangled) with the state of nucleus 615 of quantum memory 115(1). Entangled electrons 610, 630, and nuclei 615, 635 are measured to remove the states from their respective quantum memories 115(1), 115(3) in substantially the same manner described above. This removes the entanglement between central node 110 and end nodes 120(1), 120(3). Thereby creating an entangled (or Greenberger-Horne-Zeilinger (GHZ)) state between corresponding end nodes 120(1), 120(2), 120(3), 120(4) (since entangle circuit 580(2) has entangled end nodes 120(3) and 120(4) as described above).

The above process is repeated using entangle combining circuit 590(2) (for electrons 640, 650 and nuclei 645, 655 of quantum memories 115(4), 115(5)) to entangle corresponding end nodes 120(4) and 120(5). Since entangle combining circuit 580(3) has entangled end nodes 120(5) and 120(6) and entangle combining circuit 590(2) has entangled end nodes 120(1)-120(4) as described above, the entanglement of end nodes 120(4) and 120(5) by entangle combining circuit 590(2) creates an entangled (or Greenberger-Horne-Zeilinger (GHZ)) state between corresponding end nodes 120(1)-120(6). The time elapsed from stage 440 (FIG. 4) to the completion of nuclear spin measurement needs to be less than the decoherence time of the nuclear spin in the central node. If the time is less than the decoherence time, then the entangled state is kept, otherwise the entangled state is discarded. The process could then be repeated, if desired, to reattempt. FIG. 6C illustrates example communication environment 600 of FIG. 6A with a Greenberger-Horne-Zeilinger (GHZ) state established between the end nodes (which have entanglements decoupled from the central node). An embodiment may combine entanglements between the central node and individual end nodes in any order or fashion (e.g., use any quantum memories to combine the entanglements, etc.).

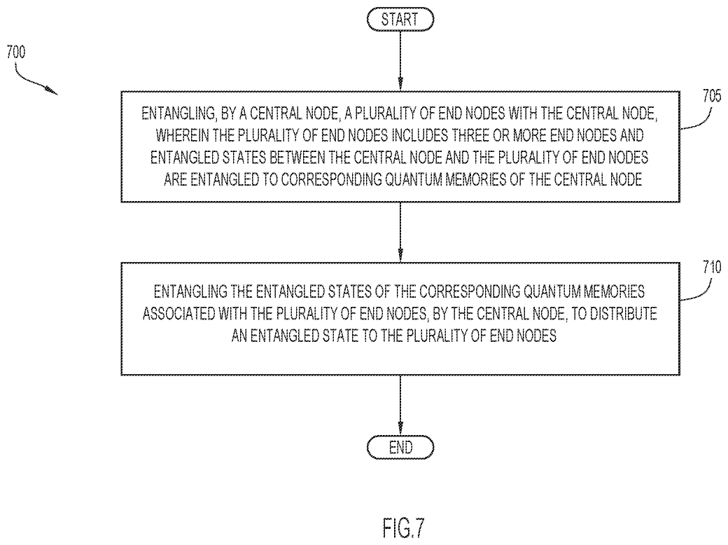

FIG. 7 illustrates a flowchart of an example method 700 for generating an entangled state among three or more nodes, according to an example embodiment. At operation 705, a central node entangles a plurality of end nodes with the central node. The plurality of end nodes includes three or more end nodes and entangled states between the central node and the plurality of end nodes are entangled to corresponding quantum memories of the central node. At operation 710, the central node entangles the entangled states of the corresponding quantum memories associated with the plurality of end nodes to distribute an entangled state to the plurality of end nodes. The time elapsed to complete the steps of FIG. 7 needs to be less than the decoherence time of the nuclear spin in the central node.

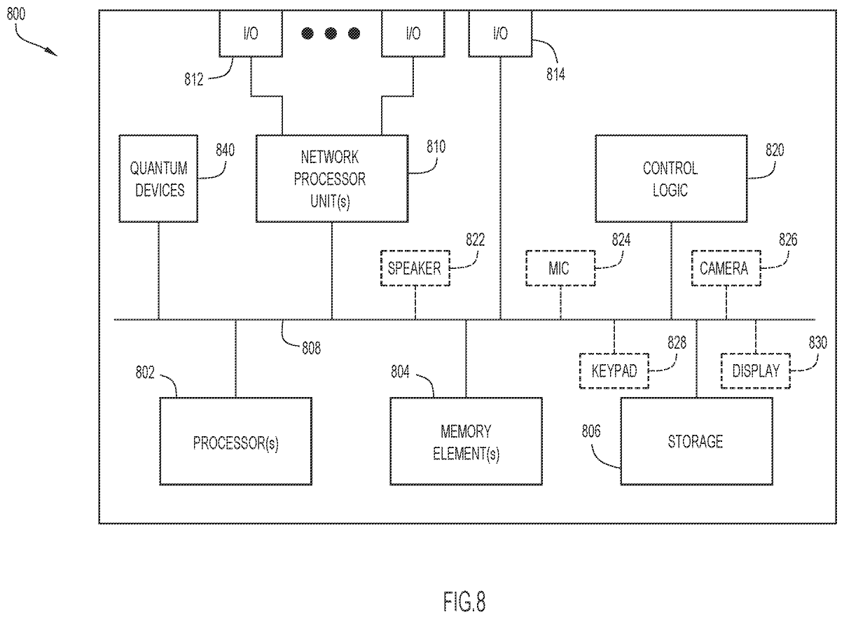

Referring to FIG. 8, FIG. 8 illustrates a hardware block diagram of a computing device 800 that may perform functions associated with operations discussed herein in connection with the techniques depicted in FIGS. 1-7. In various embodiments, a computing device or apparatus or system, such as computing device 800 or any combination of computing devices 800, may be configured as any device entity/entities (e.g., nodes, computer devices, user devices, client devices, communication devices, network devices, etc.) as discussed for the techniques depicted in connection with FIGS. 1-7 in order to perform operations of the various techniques discussed herein.

In at least one embodiment, computing device 800 may be any apparatus that may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory elements 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 to facilitate operations discussed for various embodiments described herein. In various embodiments, network processor unit(s) 810 can be configured as a combination of hardware and/or software, such as one or more Ethernet driver(s) and/or controller(s) or interface cards, Fibre Channel (e.g., and/or optical) driver(s) controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, any other I/O port(s), and/or antenna(s)/antenna array(s) now known or hereafter developed. Thus, the network processor unit(s) 810 and/or network I/O interfaces 812 may include suitable interfaces for receiving, transmitting, and/or otherwise communicating data and/or information in a network environment.

I/O interface(s) 814 allow for input and output of data and/or information with other entities that may be connected to computing device 800. For example, I/O interface(s) 814 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., client device, network device, nodes, etc.), computing device 800 may further include, or be coupled to, a speaker 822 to convey sound, microphone or other sound sensing device 824, camera or image capture device 826, a keypad or keyboard 828 to enter information (e.g., alphanumeric information, etc.), a touch screen or other display 830, and/or quantum devices 840. These items may be coupled to bus 808 or I/O interface(s) 814 to transfer data with other elements of computing device 800. Quantum devices 840 may include any conventional or other devices to perform the functions described herein (e.g., generating, transmitting, receiving, entangling, and/or processing quantum signals), such as a quantum source, quantum transmitters and receivers, quantum channels, a source of randomness, lasers or other energy sources, quantum measuring devices, quantum logic or other gates or circuits, quantum memories, etc.

In various embodiments, control logic 820 can include instructions that, when executed, cause processor(s) 802 to perform operations, which can include, but not be limited to, providing overall control operations of computing device 800; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more device entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory elements 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combinations of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: entangling, by a central node, a plurality of end nodes with the central node, wherein the plurality of end nodes includes three or more end nodes and entangled states between the central node and the plurality of end nodes are entangled to the corresponding quantum memories of the central node; and entangling the entangled states of the corresponding quantum memories associated with the plurality of end nodes, by the central node, to distribute an entangled state to the plurality of end nodes.

In one example, entangling the plurality of end nodes with the central node comprises swapping an electron state of a corresponding quantum memory of the central node representing entanglement with an end node with a nuclear state in the corresponding quantum memory.

In one example, the entangled state includes a Greenberger-Horne-Zeilinger (GHZ) state, and the method further comprises measuring elapsed time to distribute the entangled state to ensure integrity of the Greenberger-Horne-Zeilinger (GHZ) state.

In one example, entangling the entangled states of the corresponding quantum memories comprises entangling an electron state of a second quantum memory having a nuclear state entangled to a second end node with an electron state of a first quantum memory having a nuclear state entangled to a first end node.

In one example, entangling the entangled states of the corresponding quantum memories further comprises performing a controlled NOT operation between the electron state and nuclear state of the first and second quantum memories to entangle the nuclear states of the first and second quantum memories to distribute a Greenberger-Horne-Zeilinger (GHZ) state between the first and second end nodes.

In one example, entangling the entangled states of the corresponding quantum memories further comprises entangling an electron state of a third quantum memory with the electron state of the first quantum memory, wherein the third quantum memory has a nuclear spin entangled to a third end node.

In one example, entangling the entangled states of the corresponding quantum memories further comprises performing the controlled NOT operation between the electron state and nuclear state of the first and third quantum memories to entangle the nuclear states of the first and third quantum memories to distribute the Greenberger-Horne-Zeilinger (GHZ) state between the first, second, and third end nodes.

In one example, the plurality of end nodes includes four or more end nodes, and entangling the entangled states of the corresponding quantum memories comprises: entangling an electron state of a corresponding quantum memory associated with an end node j with an electron state of a quantum memory associated with an end node j+1, wherein j is an odd number greater than or equal to one and less than a quantity of end nodes; and performing a controlled NOT operation between the electron state and nuclear state of corresponding quantum memories of an initial three end nodes, and between the electron and nuclear state of quantum memories associated with nodes k, k+1 to entangle the nuclear states of the corresponding quantum memories to distribute a Greenberger-Horne-Zeilinger (GHZ) state between the four or more end nodes, wherein k is an even number greater than or equal to four and less than the quantity of end nodes.

In another form, an apparatus is provided. The apparatus comprises: a network node including a plurality of quantum memories and one or more processors, wherein the one or more processors are configured to: entangle a plurality of end nodes with the network node, wherein the plurality of end nodes includes three or more end nodes and entangled states between the network node and the plurality of end nodes are entangled to corresponding quantum memories of the network node; and entangle the entangled states of the corresponding quantum memories associated with the plurality of end nodes to distribute an entangled state to the plurality of end nodes.

In another form, one or more non-transitory computer readable storage media are provided. The non-transitory computer readable storage media are encoded with processing instructions that, when executed by one or more processors of a network node, cause the one or more processors to: entangle a plurality of end nodes with the network node, wherein the plurality of end nodes includes three or more end nodes and entangled states between the network node and the plurality of end nodes are entangled to corresponding quantum memories of the network node; and entangle the entangled states of the corresponding quantum memories associated with the plurality of end nodes to distribute an entangled state to the plurality of end nodes.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
entangling, by a central node, a plurality of end nodes with the central node, wherein the plurality of end nodes includes three or more end nodes and entangled states between the central node and the plurality of end nodes are entangled to corresponding quantum memories of the central node; and
entangling the entangled states of the corresponding quantum memories associated with the plurality of end nodes, by the central node, to distribute an entangled state to the plurality of end nodes.

2. The method of claim 1, wherein entangling the plurality of end nodes with the central node comprises:
swapping an electron state of a corresponding quantum memory of the central node entangled to an end node with a nuclear state in the corresponding quantum memory.

3. The method of claim 1, wherein the entangled state includes a Greenberger-Horne-Zeilinger (GHZ) state, and the method further comprises:
measuring elapsed time to distribute the entangled state to ensure integrity of the Greenberger-Horne-Zeilinger (GHZ) state.

4. The method of claim 1, wherein entangling the entangled states of the corresponding quantum memories comprises:
entangling an electron state of a second quantum memory having a nuclear state entangled to a second end node with an electron state of a first quantum memory having a nuclear state entangled to a first end node.

5. The method of claim 4, wherein entangling the entangled states of the corresponding quantum memories further comprises:
performing a controlled NOT operation between the electron state and nuclear state of the first and second quantum memories to entangle the nuclear states of the first and second quantum memories to distribute a Greenberger-Horne-Zeilinger (GHZ) state between the first and second end nodes.

6. The method of claim 5, wherein entangling the entangled states of the corresponding quantum memories further comprises:
entangling an electron state of a third quantum memory with the electron state of the first quantum memory, wherein the third quantum memory has a nuclear spin entangled to a third end node.

7. The method of claim 6, wherein entangling the entangled states of the corresponding quantum memories further comprises:
performing the controlled NOT operation between the electron state and nuclear state of the first and third quantum memories to entangle the nuclear states of the first and third quantum memories to distribute the Greenberger-Horne-Zeilinger (GHZ) state between the first, second, and third end nodes.

8. The method of claim 1, wherein the plurality of end nodes includes four or more end nodes, and entangling the entangled states of the corresponding quantum memories comprises:
entangling an electron state of a corresponding quantum memory associated with an end node j with an electron state of a quantum memory associated with an end node j+1, wherein j is an odd number greater than or equal to one and less than a quantity of end nodes; and
performing a controlled NOT operation between the electron state and nuclear state of corresponding quantum memories of an initial three end nodes, and between the electron and nuclear state of quantum memories associated with nodes k, k+1 to entangle the nuclear states of the corresponding quantum memories to distribute a Greenberger-Horne-Zeilinger (GHZ) state between the four or more end nodes, wherein k is an even number greater than or equal to four and less than the quantity of end nodes.

9. An apparatus comprising:
a network node including a plurality of quantum memories and one or more processors, wherein the one or more processors are configured to:
entangle a plurality of end nodes with the network node, wherein the plurality of end nodes includes three or more end nodes and entangled states between the network node and the plurality of end nodes are entangled to corresponding quantum memories of the network node; and
entangle the entangled states of the corresponding quantum memories associated with the plurality of end nodes to distribute an entangled state to the plurality of end nodes.

10. The apparatus of claim 9, wherein entangling the entangled states of the corresponding quantum memories comprises:
entangling an electron state of a second quantum memory having a nuclear state entangled to a second end node with an electron state of a first quantum memory having a nuclear state entangled to a first end node.

11. The apparatus of claim 10, wherein entangling the entangled states of the corresponding quantum memories further comprises:
performing a controlled NOT operation between the electron state and nuclear state of the first and second quantum memories to entangle the nuclear states of the first and second quantum memories to distribute a Greenberger-Horne-Zeilinger (GHZ) state between the first and second end nodes.

12. The apparatus of claim 11, wherein entangling the entangled states of the corresponding quantum memories further comprises:
entangling an electron state of a third quantum memory with the electron state of the first quantum memory, wherein the third quantum memory has a nuclear spin entangled to a third end node.

13. The apparatus of claim 12, wherein entangling the entangled states of the corresponding quantum memories further comprises:
performing the controlled NOT operation between the electron state and nuclear state of the first and third quantum memories to entangle the nuclear states of the first and third quantum memories to distribute a Greenberger-Horne-Zeilinger (GHZ) state between the first, second, and third end nodes.

14. The apparatus of claim 9, wherein the plurality of end nodes includes four or more end nodes, and entangling the entangled states of the corresponding quantum memories comprises:
entangling an electron state of a corresponding quantum memory associated with an end node j with an electron state of a quantum memory associated with an end node j+1, wherein j is an odd number greater than or equal to one and less than a quantity of end nodes; and
performing a controlled NOT operation between the electron state and nuclear state of corresponding quantum memories of an initial three end nodes, and between the electron and nuclear state of quantum memories associated with nodes k, k+1 to entangle the nuclear states of the corresponding quantum memories to distribute a Greenberger-Horne-Zeilinger (GHZ) state between the four or more end nodes, wherein k is an even number greater than or equal to four and less than the quantity of end nodes.

15. One or more non-transitory computer readable storage media encoded with processing instructions that, when executed by one or more processors of a network node, cause the one or more processors to:
entangle a plurality of end nodes with the network node, wherein the plurality of end nodes includes three or more end nodes and entangled states between the network node and the plurality of end nodes are entangled to corresponding quantum memories of the network node; and
entangle the entangled states of the corresponding quantum memories associated with the plurality of end nodes to distribute an entangled state to the plurality of end nodes.

16. The one or more non-transitory computer readable storage media of claim 15, wherein entangling the entangled states of the corresponding quantum memories comprises:
entangling an electron state of a second quantum memory having a nuclear state entangled to a second end node with an electron state of a first quantum memory having a nuclear state entangled to a first end node.

17. The one or more non-transitory computer readable storage media of claim 16, wherein entangling the entangled states of the corresponding quantum memories further comprises:
performing a controlled NOT operation between the electron state and nuclear state of the first and second quantum memories to entangle the nuclear states of the first and second quantum memories to distribute a Greenberger-Horne-Zeilinger (GHZ) state between the first and second end nodes.

18. The one or more non-transitory computer readable storage media of claim 17, wherein entangling the entangled states of the corresponding quantum memories further comprises:
entangling an electron state of a third quantum memory with the electron state of the first quantum memory, wherein the third quantum memory has a nuclear spin entangled to a third end node.

19. The one or more non-transitory computer readable storage media of claim 18, wherein entangling the entangled states of the corresponding quantum memories further comprises:
performing the controlled NOT operation between the electron state and nuclear state of the first and third quantum memories to entangle the nuclear states of the first and third quantum memories to distribute the Greenberger-Horne-Zeilinger (GHZ) state between the first, second, and third end nodes.

20. The one or more non-transitory computer readable storage media of claim 15, wherein the plurality of end nodes includes four or more end nodes, and entangling the entangled states of the corresponding quantum memories comprises:
entangling an electron state of a corresponding quantum memory associated with an end node j with an electron state of a quantum memory associated with an end node j+1, wherein j is an odd number greater than or equal to one and less than a quantity of end nodes; and
performing a controlled NOT operation between the electron state and nuclear state of corresponding quantum memories of an initial three end nodes, and between the electron and nuclear state of quantum memories associated with nodes k, k+1 to entangle the nuclear states of the corresponding quantum memories to distribute a Greenberger-Horne-Zeilinger (GHZ) state between the four or more end nodes, wherein k is an even number greater than or equal to four and less than the quantity of end nodes.
